(19) United States
(12) Patent Application Publication
(10) Pub. No.: US 2024/0093809 A1
(43) Pub. Date: Mar. 21, 2024

(54) High pressure tube and method of manufacturing the same

(71) Applicant: ALLEIMA GMBH, Werther (DE)

(72) Inventors: Thomas FROBÖSE, Werther (DE); Christofer HEDVALL, Werther (DE); Udo RAUFFMANN, Werther (DE)

(73) Assignee: ALLEIMA GMBH, Werther (DE)

(21) Appl. No.: 18/266,813

(22) PCT Filed: Dec. 10, 2021
(86) PCT No.: PCT/EP2021/085290

§ 371 Date: Jun. 13, 2023

(30) Foreign Application Priority Data
Dec. 16, 2020 (DE) 10 2020 133 779.5

(51) Int. Cl. F16L 9/02; B21C 1/18; B21C 1/22; C21D 8/10; C21D 9/14

(52) U.S. Cl. CPC F16L 9/02; B21C 1/18; B21C 1/22; C21D 8/105; C21D 9/14

(57) ABSTRACT

Tube having a length of more than 10 m suitable for high-pressure applications with internal pressure of 2 bar or more, and which is not afflicted with disadvantages exhibited by tubes produced by conventional drawing or cold pilger milling methods. The tube has a wall thickness equal to or larger than the internal diameter, an axial length of 12 m or more, a tensile strength Rm of 850 N/mm² or more, and a mean roughness index Ra of the inner wall surface of 0.8 μm or less. Furthermore, a method of manufacturing such a tube forms a hollow into a tubular intermediate in a first forming step according to the cold forming method, the tubular intermediate thus obtained is annealed, and the annealed tubular intermediate is formed into a tube in a second forming step according to the cold forming method.

### TECHNICAL AREA

The present disclosure relates to a tube for carrying a fluid, wherein the tube has a wall thickness at least as large as the inner diameter of the tube and wherein the length of the tube is at least 12 m. Furthermore, a method is described according to which a tube of the aforementioned type is obtainable.

### BACKGROUND OF THE INVENTION

For plants where gases or liquids have to be carried through tubes at high pressure, tubes are needed that can withstand the special pressure requirements. For example, from a working pressure of over 2 bar, tube made of metal are often used in which the thickness of the tube wall is at least as large as the inner diameter of the tube. Manufacturing of such tubes suitable for high-pressure applications is a major challenge, especially when particularly long tubes are required, for example with a length of more than 10 m or even more than 100 m.

In principle, such long high-pressure tubes could be manufactured by drawing. However, the tubes manufactured by this method often have too low elongation at break, which is associated with severe limitations in further processing and application. In addition, the roughness of the inner surfaces of long, drawn high-pressure tubes is often too large.

A high elongation at break is desirable, in particular for transport to the customer but also for processability when installing a high-pressure tube in the plant. This allows, for example, delivery “in a ring”, wherein the high-pressure tube is helically wound to save space.

An alternative manufacturing process for high-pressure tubes is cold pilger milling, in which a hollow cylindrical blank (shell) is cold reduced by compressive stresses in the cooled state. For this purpose, the shell is pushed over a mandrel during milling and is enclosed from the outside by two rolls, which roll shell out longitudinally over the mandrel.

The cold pilger milling process has the advantage that it can produce tubes which can achieve higher elongation at break values than drawn tubes. However, this is often at the expense of the tensile strength of the tube, especially if tubes significantly longer than 10 m are to be produced.

Therefore, there is a need for a tube longer than 10 m that is suitable for high-pressure applications and that does not suffer from the disadvantages typically associated with such tubes manufactured by conventional drawing or cold pilger milling processes.

### SUMMARY OF THE INVENTION

Therefore, according to the present disclosure, a tube for carrying a fluid is proposed which tube comprises an outer wall surface, an inner wall surface, an outer diameter, an inner diameter, a wall thickness given by a half of a difference between the outer diameter and the inner diameter, and an axial length,
wherein the wall thickness is equal to or larger than the inner diameter,
wherein the axial length is 12 m or more,
wherein the tensile strength Rm is 850 N/mm² or more, and
wherein the mean roughness index Ra of the inner wall surface is 0.8 μm or less.

The tube proposed herein is very suitable for high-pressure applications due to its large wall thickness, which is at least as large as the inner diameter of the tube. The tensile strength, with a value of Rm 850 N/mm², is in a range that can usually only be achieved by drawn tubes. However, the tube proposed here is not associated with the disadvantage of excessive roughness of the inner wall surface of the tube. On the contrary, the mean roughness index Ra of the inner wall surface of the tube proposed here is max. 0.8 μm.

In the tube proposed herein, the wall thickness is equal to or larger than the inner diameter of the tube. In some embodiments, the wall thickness is equal to at least 1.1 times the inner diameter, at least 1.5 times the inner diameter, or at least 2.0 times the inner diameter. In some embodiments, the wall thickness is up to 2.5 times the inner diameter, up to 3.0 times the inner diameter, or up to 5 times the inner diameter.

In some embodiments of the tube proposed herein, the inner diameter of the tube is 5 mm or less, 4 mm or less, or 3 mm or less. In some embodiments of the tube proposed herein, the inner diameter of the tube is at least 1 mm or at least 2 mm or at least 3 mm.

In some embodiments of the tube proposed herein, the outer diameter and/or the inner diameter has a tolerance of +/−0.15 mm. In some embodiments of the tube proposed herein, the outer diameter and/or the inner diameter has a tolerance of +/−0.10 mm, and in some embodiments of the tube proposed herein, the outer diameter and/or the inner diameter has a tolerance of +/−0.05 mm.

In some embodiments, the tube proposed herein achieves a strength to a pressurized fluid in its interior of 500 bar or more as a function of wall thickness and internal diameter. In some embodiments, the tube achieves a strength to a pressurized fluid in its interior of 600 bar or more.

The axial length of the tube proposed herein is 12 m or more. In some embodiments, the axial length is at least 20 m, at least 50 m, at least 75 m, or even at least 100 m. In particular, the maximum axial length of the tube proposed herein is determined by the maximum feasible length of the shell. In some embodiments, the maximum axial length is up to up to 150 m, up to 200 m or even up to 250 m.

The tensile strength Rm of the tube proposed herein is at least 850 N/mm². In some embodiments, the tensile strength Rm is at least 900 N/mm², at least 950 N/mm², or even at least 1000 N/mm². The tensile strength is calculated from the results of a tensile test in which the finished tube is subjected to a tensile force in the longitudinal direction until a crack appears in the tube. The tensile strength is given as the maximum tensile force achieved in the tensile test relative to the original cross-section of the wall of the tube.

The mean roughness index Ra of the inner wall surface is 0.8 μm or less for the tube proposed herein. In some embodiments, the mean roughness index Ra of the inner wall surface is 0.75 μm or less, 0.7 μm or less, or even only 0.65 μm or less.

The mean roughness index indicates the average distance of a measuring point on the inner wall surface of the tube to the center line. The center line intersects the real profile within the reference section in such a way that the sum of the profile deviations in a plane parallel to the center line is distributed over the length of the measured section. The mean roughness index thus corresponds to the arithmetic mean of the deviation from the center line in terms of amount.

In some embodiments of the tube disclosed herein, the elongation at break A is 12% or more. This is a value that is not typically achieved by conventional drawing methods in the range of tube lengths and pressure tolerance ranges relevant herein. In some embodiments of the tube proposed herein, the elongation at break A is at least 13%, at least 14%, at least 15%, or even at least 20%.

The elongation at fracture indicates the permanent elongation of the tube after fracture in a tensile test in the longitudinal direction, related to an initial gauge length of the tube before the tensile test. The elongation at fracture is thus the permanent change in length after fracture, related to the initial gauge length of a specimen in the tensile test. The elongation at break characterizes the deformability (or ductility) of the tube.

In possible applications of the tube according to the invention, the tube is processed at the end customer, i.e. in particular bent. Such bending significantly reduces the elongation at break A. Therefore, it is necessary that the tube has a high elongation at break with previously defined lower limits after pilger milling, so that the tube still shows sufficient elongation at break after final bending.

In some embodiments of the tube proposed herein, the elastic limit or yield strength (Rp 0.2) is 750 N/mm² or more. In some embodiments, the elastic limit is at least 800 N/mm², at least 850 N/mm², or even at least 900 N/mm².

The elastic limit of the tube is the magnitude of the mechanical stress below which the material is elastic, i.e. it returns to its original shape when the load is removed (non-residual/reversible deformation). When the elastic limit is exceeded, irreversible elongation or compression or plastic deformation occurs.

In some embodiments, the tube proposed herein is made of metal. In some embodiments, the tube is made of steel, and in some embodiments, the material of which the tube consists is alloyed or unalloyed stainless steel (<0.025 wt % sulfur, <0.025 wt % phosphorus).

In some embodiments, the tube comprises a duplex steel (two-phase structure of ferrite-(α-iron) matrix with islands of austenite), a duplex stainless steel, an austenitic steel (face-centered cubic crystal structure), or an austenitic stainless steel. In some embodiments, the tube comprises a nickel-containing steel or stainless steel alloy having a nickel content in the range of 1 to 25 wt % or in the range of 2 to 15 wt %, optionally with an additional content of other alloying elements, which may be selected without limitation from chromium, molybdenum, nickel, nitrogen, copper, manganese, silicon, carbon, tungsten, cobalt, aluminum, vanadium, titanium, niobium, and combinations thereof.

In some embodiments, the tube comprises an austenitic stainless steel designated 316L or UNS S31603. In some embodiments, this austenitic stainless steel comprises, in weight percent
C up to 0.040,
Mn up to 2.00,
Si up to 1.00,
Cr in a range from 16.00 to 19.00,
Ni in a range from 10.00 to 14.00,
Mo in a range from 2.00 to 3.00,
Cu up to 0.80,
P up to 0.050,
S up to 0.030,
N up to 0.20 and
with a residual of Fe and unavoidable impurities.

In some embodiments, this austenitic stainless steel consists of, in weight percent
C up to 0.040,
Mn up to 2.00,
Si up to 1.00,
Cr in a range from 16.00 to 19.00,
Ni in a range from 10.00 to 14.00,
Mo in a range from 2.00 to 3.00,
Cu up to 0.80,
P up to 0.050,
S up to 0.030,
N up to 0.20 and
with a residual Fe and unavoidable impurities.

In some embodiments, the tube comprises an austenitic stainless steel denoted as 21-6-9 according to UNS S21900. In some embodiments, this austenitic stainless steel comprises, in weight percent
C up to 0.080,
Si up to 1.00,
Mn in a range from 8.00 to 10.00,
P up to 0.030,
S up to 0.030,
Cr in a range from 19.00 to 21.50,
Ni in a range from 5.50 to 7.50,
Mo up to 0.75,
Cu up to 0.75,
N in a range from 0.15 to 0.40 and
with a residual Fe and unavoidable impurities.

In some embodiments, this austenitic stainless steel consists of, in weight percent
C up to 0.080,
Si up to 1.00,
Mn in a range from 8.00 to 10.00,
P up to 0.030,
S up to 0.030,
Cr in a range from 19.00 to 21.50,
Ni in a range from 5.50 to 7.50,
Mo up to 0.75,
Cu up to 0.75,
N in a range from 0.15 to 0.40 and
with a residual of Fe and unavoidable impurities.

In some embodiments, the 21-6-9 stainless steel comprises or consists of the aforementioned composition with C up to 0.040 (wt %).

Both 316L and 21-6-9 are particularly suitable for carrying hydrogen.

In some embodiments, the tube is coiled into a coil.

Also disclosed herein is a method of manufacturing a tube suitable for high pressure applications, in one embodiment as previously described. In particular, a method for manufacturing a tube according to any one of the previously described embodiments is proposed, the method comprising the following steps:
Providing a hollow, the hollow comprising an outer wall surface, an inner wall surface, an outer diameter, an inner diameter, a wall thickness defined by a half of a difference between the outer diameter and the inner diameter, and an axial length,
Cold woring of the hollow into a tubular intermediate product in a first working step,
temoering of the tubular intermediate, and
Cold working the tubular intermediate product into the tube in a second working step.

The method proposed herein is used to produce a tube comprising the characteristics given above for the tube described therein, wherein the wall thickness of the tube is at least as large as its inner diameter, the axial length of the tube is at least 12 m, the tensile strength of the tube Rm is at least 850 N/mm², and the mean roughness index Ra of the inner wall surface is at most 0.8 μm.

In some embodiments of the process proposed herein, providing the hollow is accomplished by hot extrusion.

In some embodiments of the method, the hollow undergoes a first reduction in wall thickness and a first reduction in outer diameter in the first working step, and the tubular intermediate product undergoes a second reduction in wall thickness and a second reduction in outer diameter in the second working step, wherein the first reduction in wall thickness is larger than the second reduction in wall thickness and the first reduction in outer diameter is larger than the second reduction in outer diameter.

In some embodiments, the first reduction in wall thickness is larger than the second reduction in wall thickness by at least 5%, at least 10%, or at least 15%. In some embodiments, the first reduction in wall thickness is larger than the second reduction in wall thickness by up to 20%, up to 25%, or even up to 30%.

In some embodiments, the first reduction in outer diameter is at least 5%, at least 10%, or at least 15% larger than the second reduction in outer diameter. In some embodiments, the first reduction in outer diameter is larger than the second reduction in outer diameter by up to 20%, up to 25%, or even up to 30%.

In some embodiments, the hollow has an axial length of 12 m or less, 10 m or less, or 8 m or less, and the tube obtained from the hollow according to the method has an axial length of 12 m or more, 20 m or more, or 50 m or more.

In some embodiments, the tube obtained according to the method has a length in the range described above for the tube disclosed in the present disclosure.

In some embodiments of the method proposed herein, the tube is coiled after the second working step. In some embodiments wherein the tube is coiled, the tube is not tempered after the second working step and prior to coiling.

In some embodiments of the process described, cold working is cold drawing. In cold drawing, the first working step is a first drawing step and the second working step is a second drawing step.

In some embodiments of the process described, cold working is cold pilger milling. In cold pilger milling, the first working step is a first cold pilger milling step and the second working step is a second cold pilger milling step.

Insofar as reference is made in the above description or in the following claims to either the tube proposed herein or to the method of manufacturing a tube proposed herein, the features mentioned are disclosed for both the tube proposed herein and the method of manufacturing a tube proposed herein.

### SHORT DESCRIPTION OF THE FIGURE

Further advantages, features and applications of the present disclosure will become apparent with reference to the following description of embodiments and the accompanying FIGURE. The foregoing, as well as the following detailed description of embodiments, will be better understood when read in conjunction with the accompanying drawings. The embodiments shown are not limited to the exact arrangement.

FIG. 1 is a schematic flowchart of a method according to the present disclosure for manufacturing a tube.

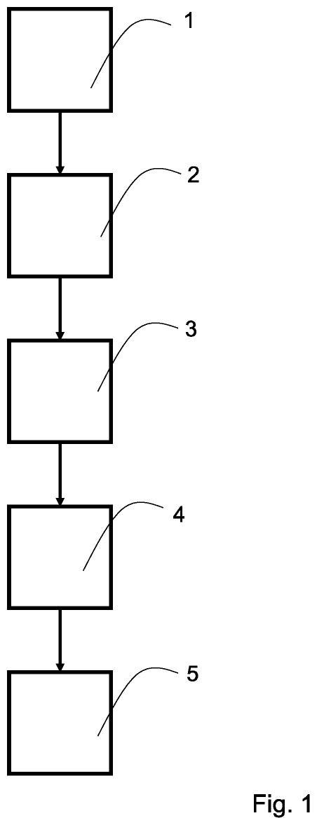

### DETAILED DESCRIPTION

In the example shown, a tube is produced using a process with five process steps 1 to 5. In step 1, a hollow comprising a length of 10 m and a dimension of 70 mm×8 mm (outside diameter×wall thickness) is provided. This hollow enters a cold pilger milling mill and is reduced to dimensions of 33 mm×4 mm by cold pilger milling in a first cold pilger milling step 2. The tubular intermediate product obtained by the first cold pilger milling 2 is tempered in step 3.

In a second cold pilger milling step 4, the tubular intermediate product is reduced to the tube with dimensions of 14 mm×3 mm by cold pilger milling. After the two pilger steps 2, 4, the outgoing tube has a length of about 120 m.

The first cold pilger milling step can be regarded as coarse pilgering and the second cold pilger milling step as fine pilgering. Overall, the reduction in cross-section from the shell to the finished tube is larger than 90%, while in the first cold pilger milling step the reduction is 75% and in the second cold pilger milling step 65%. In a final step 5, the finished tube leaving the second cold pilger milling step 4 is coiled.

In the example described here, the finished tube has a tensile strength Rn of 671 MPa, an elastic limit of 495 MPa, an elongation at break A of 15.9%, and a mean roughness index Ra of the inner wall surface of 0.5 μm.

For the purposes of the original disclosure, it is pointed out that all features as they become apparent to a person skilled in the art from the present description, the drawings and the claims, even if they have been specifically described only in connection with certain further features, can be combined both individually and in any desired combinations with other of the features or groups of features disclosed here, unless this has been expressly excluded or technical circumstances make such combinations impossible or pointless. The comprehensive, explicit presentation of all conceivable combinations of features is omitted here only for the sake of brevity and readability of the description.

While the invention has been illustrated and described in detail in the drawings and the foregoing description, this illustration and description is by way of example only and is not intended to limit the scope of protection as defined by the claims. The invention is not limited to the disclosed embodiments.

Variations of the disclosed embodiments will be obvious to those skilled in the art from the drawings, description, and appended claims. In the claims, the word “comprising” does not exclude other elements or steps, and the indefinite article “a” does not exclude a plurality. The mere fact that certain features are claimed in different claims does not preclude their combination. Reference signs in the claims are not intended to limit the scope of protection.

1. A tube for carrying a fluid, comprising:
an outer wall surface, an inner wall surface, an outer diameter, an inner diameter, a wall thickness defined by a half of a difference between the outer diameter and the inner diameter, and an axial length,
wherein the wall thickness is equal to or larger than the inner diameter,
wherein an axial length is 12 m or more,
wherein a tensile strength Rm is 850 N/mm² or more, and
wherein a mean roughness index Ra of the inner wall surface is 0.8 μm or less.

2. The tube according to claim 1, wherein an elastic limit (Rp0.2) is 750 N/mm² or more.

3. The tube according to claim 1, wherein the tube is made of a stainless steel.

4. The tube according to claim 1, wherein the axial length is 100 m or more.

5. The tube according to claim 1, wherein the tube is coiled into a coil.

6. A method of manufacturing a tube, comprising the steps of:
providing a hollow, the hollow comprising an outer wall surface, an inner wall surface, an outer diameter, an inner diameter, a wall thickness defined by a half of a difference between the outer diameter and the inner diameter, and an axial length,
cold working of the hollow into a tubular intermediate product in a first working step,
tempering of the tubular intermediate product and
cold working the tubular intermediate product into the tube in a second working step,
wherein a wall thickness of the tube is equal to or larger than an inner diameter of the tube,
wherein an axial length of the tube is 12 m or more,
wherein a tensile strength Rm of the tube is 850 N/mm² or more, and
wherein a mean roughness index Ra of an inner wall surface of the tube is 0.8 μm or less.

7. The method according to claim 6, wherein in the first working step the hollow undergoes a first reduction in wall thickness and a first reduction in outer diameter,
wherein in the second working step the tubular intermediate product undergoes a second reduction in wall thickness and a second reduction in outer diameter, and
wherein the first reduction in wall thickness is larger than the second reduction in wall thickness and the first reduction in outer diameter is larger than the second reduction in outer diameter.

8. The method according to claim 6, wherein the hollow comprises an axial length of 12 m or less.

9. The method according to claim 6, wherein the tube is coiled after the second working step.

10. The method according to claim 9, wherein the tube is not tempered after the second working step and before the coiling step.

11. The method according to claim 6, wherein the cold working is cold drawing or cold pilger milling.

12. A use of a tube according to claim 1 for carrying a fluid comprising a pressure of 800 bar or more.

13. The method according to claim 8, wherein the axial length of the tube is 100 m or more.

14. The method according to claim 7, wherein the hollow comprises an axial length of 12 m or less.

15. The method according to claim 14, wherein the axial length of the tube is 100 m or more.
